(19) United States
(12) Patent Application Publication
(10) Pub. No.: US 2016/0063598 A1
(43) Pub. Date: Mar. 3, 2016

(54) SOCIAL GIFTING

(71) Applicants: Aditi Arun Vad, Santa Clara, CA (US); Aayush Mahendru, Santa Clara, CA (US)

(72) Inventors: Aditi Arun Vad, Santa Clara, CA (US); Aayush Mahendru, Santa Clara, CA (US)

(21) Appl. No.: 14/473,542

(22) Filed: Aug. 29, 2014

(51) Int. Cl. G06Q 30/06

(52) U.S. Cl. CPC G06Q 30/0631; G06Q 30/0641; G06Q 50/01

(57) ABSTRACT

A system and method for a social gifting application are described. The system accesses social network data of contacts of a social network of a user from a social network service provider, and marketplace data of the contacts and the user from a marketplace application. A gift event is identified based on the social network data of a contact of the user. A gift recipient is identified from the gift event. A gift profile of the gift recipient is generated based on the social network data of the gift recipient. The system accesses gift parameters of the user and product availability from the marketplace application and generates a gift suggestion based on the gift event of the gift recipient, the gift profile of the gift recipient, and gift parameters of the user.

### TECHNICAL FIELD

This application relates generally to the field of computer technology and, in a specific example embodiment, to a method and system for generating gift suggestions based on social network profile data.

### BACKGROUND

Social network service providers allow users to send a gift to other users in their social network. However, those gifts are limited to gift cards and may not be relevant to the recipient. As such, the gifting user is limited in his choice of gifts by the social network service providers.

### BRIEF DESCRIPTION OF THE DRAWINGS

The present disclosure is illustrated by way of example, and not by way of limitation, in the figures of the accompanying drawings.

FIG. 1 is a network diagram depicting a network system having a client-server architecture configured for exchanging data over a network, according to one embodiment.

FIG. 2 shows a block diagram illustrating one example embodiment of a marketplace application.

FIG. 3 shows a block diagram illustrating one example embodiment of a social gifting application.

FIG. 4 shows a flow diagram illustrating one example embodiment of an operation of a social gifting application.

FIG. 5 shows a flow diagram illustrating another example embodiment of an operation of a social gifting application.

FIG. 6 shows an interaction diagram illustrating one example embodiment of an operation of a social gifting application.

FIG. 7 shows a diagrammatic representation of machine, in the example form of a computer system, within which a set of instructions may be executed to cause the machine to perform any one or more of the methodologies discussed herein.

### DETAILED DESCRIPTION

Although the present disclosure is described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

A system and method for utilizing a social gifting application are described. The system accesses social network data of contacts of a social network of a user from a social network service provider, and marketplace data of the contacts and the user from a marketplace application. A gift event is identified based on the social network data of a contact of the user. A gift recipient is identified from the gift event. A gift profile of the gift recipient is generated based on the social network data of the gift recipient. The system accesses gift parameters of the user and product availability from the marketplace application and generates a gift suggestion based on the gift event of the gift recipient, the gift profile of the gift recipient, and gift parameters to the user.

In one example embodiment, the social network data comprises a profile of the contact and a posting from the contact with the social network service provider. The system may identify key words from the posting of contacts of the social network of the user, and correlate the posting to a gift category based on the key words. A social event from the profile of the contact may also be correlated with a gift category.

In one example embodiment, the marketplace data comprises historical transaction data from the user and the contacts in the marketplace application. The system generates the gift profile of the gift recipient based on the historical transaction data of the gift recipient.

In one example embodiment, product categories are identified based on a marketplace application browsing history of the gift recipient and past purchases of the gift recipient. Product categories are mapped corresponding to social events of the gift recipient or postings from the gift recipients.

In one example embodiment, the system presents the user with the product categories and a plurality of price ranges. The system receives a selection of at least one product category and at least one price range from the user. The system identifies a product based on the selected product category and price range, and determines an availability of the product in the marketplace application. The system presents the user with the product as a gift suggestion for the gift recipient.

### System Architecture

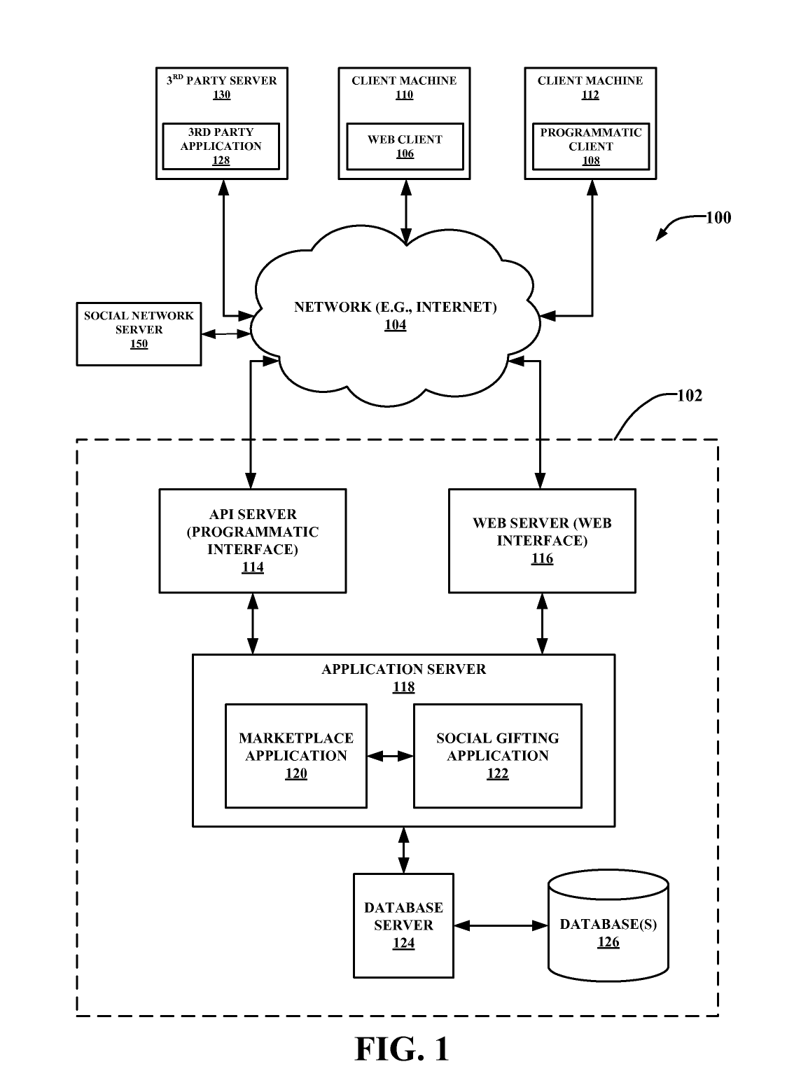

FIG. 1 is a network diagram depicting a network system 100 having a client-server architecture configured for exchanging data over a network, according to one embodiment. For example, the network system 100 may be a publication/publisher system where clients may communicate and exchange data within the network system 100. The data may pertain to various functions (e.g., online item purchases) and aspects (e.g., managing content and user reputation values) associated with the network system 100 and its users. Although illustrated herein as a client-server architecture, other embodiments may include other network architectures, such as peer-to-peer or distributed network environments.

A data exchange platform, in an example form of a marketplace application 120 and a social gifting application 122, may provide server-side functionality, via a network 104 (e.g., the Internet) to one or more clients. The one or more clients may include users that utilize the network system 100 and, more specifically, the marketplace application 120 and a social gifting application 122, to exchange data over the network 104. These transactions may include transmitting, receiving (communicating), and processing data to, from, and regarding content and users of the network system 100. The data may include, but is not limited to, content and user data such as user profiles; user attributes; product and service reviews and information, such as pricing and descriptive information; product, service, manufacturer, and vendor recommendations and identifiers; product and service listings associated with buyers and sellers; auction bids; and transaction data, such as collection and payment, shipping transactions, shipping label purchases, and real time synchronization of financial journals, among others.

In various embodiments, the data exchanges within the network system 100 may be dependent upon user-selected functions available through one or more client or user interfaces (UIs). The UIs may be associated with a client machine, such as a client machine 110 using a web client 106. The web client 106 may be in communication with the marketplace application 120 via a web server 116. The UIs may also be associated with a client machine 112 using a programmatic client 108, such as a client application, or a third party server 130 with a third party application 128. It can be appreciated that in various embodiments, the client machines 110, 112, or third party server 130 may be associated with a buyer, a seller, a third party electronic commerce platform, a payment service provider, a shipping service provider, or a financial institution system, each in communication with the networked system 102 and optionally each other. The buyers and sellers may be any one of individuals, merchants, or service providers.

Turning specifically to the marketplace application 120 and the social gifting application 122, an application program interface (API) server 114 and the web server 116 are coupled to, and provide programmatic and web interfaces respectively to, one or more application servers 118. The application server 118 hosts one or more marketplace applications 120 and social gifting applications 122. The application server 118 is, in turn, shown to be coupled to one or more database servers 124 that facilitate access to one or more databases 126.

In one embodiment, the web server 116 and the API server 114 communicate and receive data pertaining to listings and transactions, among other things, via various user input tools. For example, the web server 116 may send and receive data to and from a toolbar or webpage on a browser application (e.g., web client 106) operating on a client machine (e.g., client machine 110). The API server 114 may send and receive data to and from an application (e.g., programmatic client 108 or third party application 128) running on another client machine (e.g., client machine 112 or third party server 130).

In one embodiment, the marketplace application 120 provides listings and price-setting mechanisms whereby a user may be a seller or buyer who lists or buys goods or services (e.g., for sale) published on the marketplace application 120.

In one embodiment, the social gifting application 122 includes a system and a method for generating gift suggestions to a user of the marketplace application 120. For example, the social gifting application 122 accesses social network information of the user from a social network service provider. The social network service provider may include a social network server 150 configured to exchange information between users based on their social connections. The social network information may include profile information of contacts of the user. Contacts may be friends, family, acquaintances of the user. Contacts may include any entity or person that the user has confirmed a relationship with to the social network service provider. The profile information may include, for example, an address, a birthdate and an anniversary date. The social network information may also include postings (e.g., information the contact has posted with the social network service provider).

The social gift application 122 may also determine whether any of the contacts in the social network of the user are also registered users of the marketplace application 120. Marketplace data may be retrieved for users that are registered users with the marketplace application 120. The marketplace data may include transaction history and browsing history on the marketplace application 120.

The social gift application 122 generates a gift suggestion based on the social network information and marketplace data of contacts in the social network of the user. For example, the social gift application 122 determines that the birthday of a friend of the user is coming up from the social network profile of the friend. The social gift application 122 accesses purchase history from the friend on the marketplace application 120. The social gift application 122 determines that the friend has recently purchased a laptop and other small electronic gadgets from the purchase history and browsing history of electronic gadgets. The social gift application 122 may thus generate a list of available popular electronic gadgets within a particular price range to the user as suggested gifts. For example, the social gift application 122 may suggest accessories to complement the recently purchased laptop.

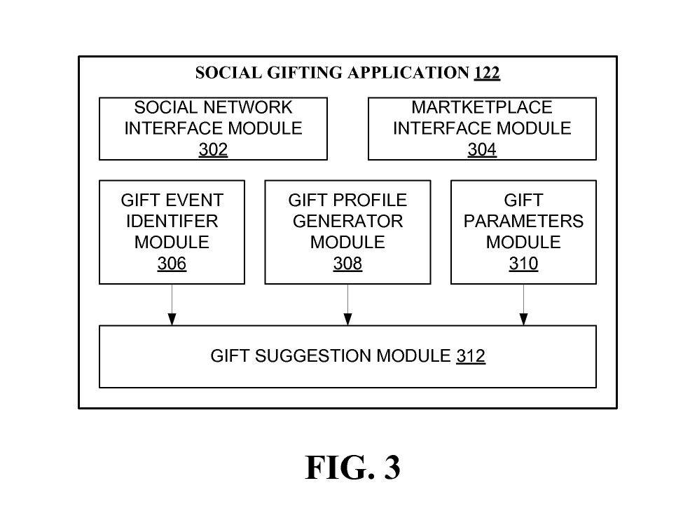

In another example, the social gift application 122 determines that a friend of the user had a recent job promotion. The social gift application 122 accesses social network information from the friend and determines that the friend frequently goes to movie theaters and eats out often at sushi restaurants. The social gift application 122 may thus suggest movie passes (e.g., for movie theaters within a predetermined distance of an address of the gift recipient) and sushi restaurants gift card (e.g., within a predetermined distance of the address of the gift recipient) to the user based on the social network information. The social gifting application 122 is described in more detail below with respect to FIG. 3. In one embodiment, some of the functions and operations of the social gifting application 122 may be incorporated into the marketplace application 120.

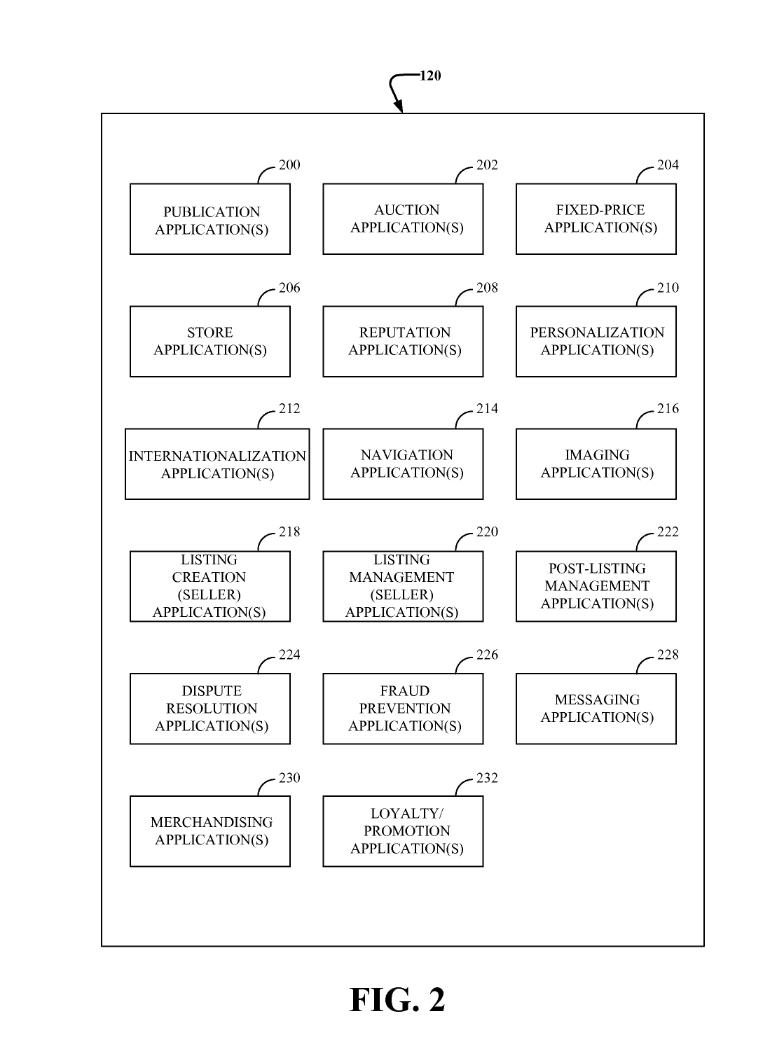

FIG. 2 shows a block diagram illustrating one example embodiment of the marketplace application 120. The marketplace application 120 may be hosted on dedicated or shared server machines (not shown) that are communicatively coupled to enable communications between server machines. The marketplace application 120 and the social gifting application 122 themselves are communicatively coupled (e.g., via appropriate interfaces) to each other and to various data sources, so as to allow information to be passed between the marketplace application 120 and the social gifting application 122 or so as to allow the marketplace application 120 and the social gifting application 122 to share and access common data. The marketplace application 120 and the social gifting application 122 may, furthermore, access one or more databases 126 via the database servers 124.

The networked system 102 may provide a number of publishing, listing, and price-setting mechanisms whereby a seller may list (or publish information concerning) goods or services for sale; a buyer can express interest in or indicate a desire to purchase such goods or services; and a price can be set for a transaction pertaining to the goods or services. To this end, the marketplace application 120 is shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. For example, consider that where the networked system 102 supports person-to-person trading, users may have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page in which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may, accordingly, include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings available via the networked system 102 as visually informing and attractive as possible, the marketplace application 120 may include one or more imaging applications 216, which users may utilize to upload images for inclusion within the listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users)). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotion applications 232. For example, a buyer may earn loyalty or promotion points for each transaction established and/or concluded with a particular seller, and be offered a reward for which accumulated loyalty points can be redeemed.

FIG. 3 shows a block diagram illustrating one example embodiment of the social gifting application 122. The social gifting application 122 may include a social network interface module 302, a marketplace interface module 304, a gift event identifier module 306, a gift profile generator module 308, a gift parameters module 310, and a gift suggestion module 312.

The social network interface module 302 has access to social network service providers. As previously described, the social network service providers may include a server configured to exchange information between and from users based on their social connections. In one embodiment, the user provides an authorization to the social gifting application 122 to access social network information of the user from the corresponding social network service provider. The social network information may include information about the user and other users (e.g., contacts) in the social network that are connections or have some pre-existing relationship with the user. The social network information may include a social network profile and social network postings. The social network profile may include for example, a name, an address, a telephone number, a current location, a birthdate, an anniversary date of the user of the marketplace application 120 with the social network service provider. The social network profile may also include profile information from friends of the user. The social network postings may include postings or information from the user or other users. For example, the social network postings may include a status update describing a status of the user or other users (e.g., “Having fun watching a sci-fi movie at the local theater with Nathan”). As such, the social network interface module 302 retrieves social network information related to the user and other users from the social network of the user.

The marketplace interface module 304 accesses marketplace data of the user at the marketplace application 120. The marketplace data may include transaction history, past purchases, and browsing history on the marketplace application 120 by the user. In another embodiment, the marketplace interface module 304 determines whether any of the contacts in the social network of the user are also registered users of the marketplace application 120. Marketplace data from those registered users may also be retrieved. For example, the marketplace interface module 304 retrieves purchase history from a friend of the user. In another example, the marketplace interface module 304 can access other third party marketplace applications to determine whether any of the friends of the user are also registered users with the third party marketplace application.

The gift event identifier module 306 identifies gift events related to the social network of the user using the social network information from the social network interface module 302 and the marketplace data from the marketplace interface module 304. For example, the gift event identifier module 306 identifies that a birthday or anniversary of a friend of the user is approaching based on the profile data of the friend in the social network information. Furthermore, the gift event identifier module 306 can identify gifting events based on content from the social network information. For example, the social network information may include a posting from a friend saying “first day on the job.” The gift event identifier module 306 may parse the content of the posting to identify key words related to gifting events. For example, possible key words related to a gifting event, such as a new job, may include: “first day,” “new job,” “congratulations,” and “accepted offer.” Thus, these key words may already be associated with the predefined gift event: “new job.”

In another example, the social network information may include a posting including any of the following key words: “proposed,” “girlfriend,” and “engaged”. The gift event identifier module 306 may thus identify a gift event (e.g., engagement) associated with these key words.

In another example, the marketplace data may include browsing history related to engagement rings from a friend of the user. The gift event identifier module 306 may thus identify a gift event (e.g., engagement) associated with the browsing history of the friend of the user.

The gift profile generator module 308 may generate a gift profile of the gift recipient. The gift profile may identify product categories based on a marketplace application browsing history of the gift recipient and past purchases of the gift recipient. For example, the gift profile may include basic information such as name and delivery address. However, the gift profile generator module 308 may mine data from the social network information and the marketplace data to enhance the gift profile of the recipient. For example, the social network information of the recipient may indicate that the recipient made numerous comments on sci-fi shows. The marketplace data may indicate that the recipient frequently browses electronic gadgets on the marketplace application 122. As such, the gift profile generator module 308 may search for products related to sci-fi shows in the electronic toy category of the marketplace application 122.

In another example, the gift profile generator module 308 determines that a friend of the user likes a music artist based on the social network information. The gift profile generator module 308 also determines that the friend has browsed for albums from the music artist but has not purchased any. The gift profile generator module 308 may thus generate a gift suggestion that include music albums (that have not been purchased by the friend) by the music artist.

In another example, the gift profile generator module 308 may indicate that the friend has browsed for saris from India based on the social network information (e.g. posting saying “traveled to India and loved it”) and the marketplace data (e.g. browsing history shows browsing for saris from India).

In another embodiment, the gift profile generator module 308 may identify a delivery address of the gift recipient and suggest gift products that are available to be shipped domestically within the country of the gift recipient.

The gift parameters module 310 accesses gift parameters, product availability, and price range. Gift parameters may identify a type of gift desired from an input of the user. For example, the user may only wish to gift relatively small products, gift cards, or electronic products. The user may identify or select a product category from a list of product categories associated with the gift profile of the gift recipient. For example, the gift profile generator module 308 determines that the gift profile of a gift recipient includes electronics, books, and music. The user may select only book and music with free shipping from the gift profile.

The gift parameters module 310 may also determine which products from the identified product categories in the gift profile are available for sale from the marketplace application 120. This may occur before or after the selection of a product category by the user.

The gift parameters module 310 may also allow the user to select a price range for the gift. For example, the user may indicate that he is looking for a gift in the price range of $20 to $30.

Accordingly, the gift suggestion module 312 generates a gift suggestion based on the gift event of the gift recipient, the gift profile of the gift recipient, and the gift parameters provided by the user. In one example embodiment, the gift suggestion identifies a product based on the selected product category and price range, verifies an availability of the product in the marketplace application, and presents the user with the product as the gift suggestion for the gift recipient. As a result, the user is presented with an available product.

In another embodiment, the gift suggestion module 312 allows the user to purchase the product and request delivery of the product based on the social network information. For example, the social network posting of a friend may say “heading off to Hotel xyz in Hawaii for honeymoon tomorrow.” The gift suggestion module 312 may receive a selection of a bottle of champagne from a list of suggested products. The gift suggestion module 312 further communicates custom delivery instructions to the marketplace application 120. The custom delivery instructions may instruct delivery of the bottle of champagne at Hotel xyz on a specific delivery date. The specific delivery date may be determined based on the social network information (e.g., posting “just arrived in Hawaii”).

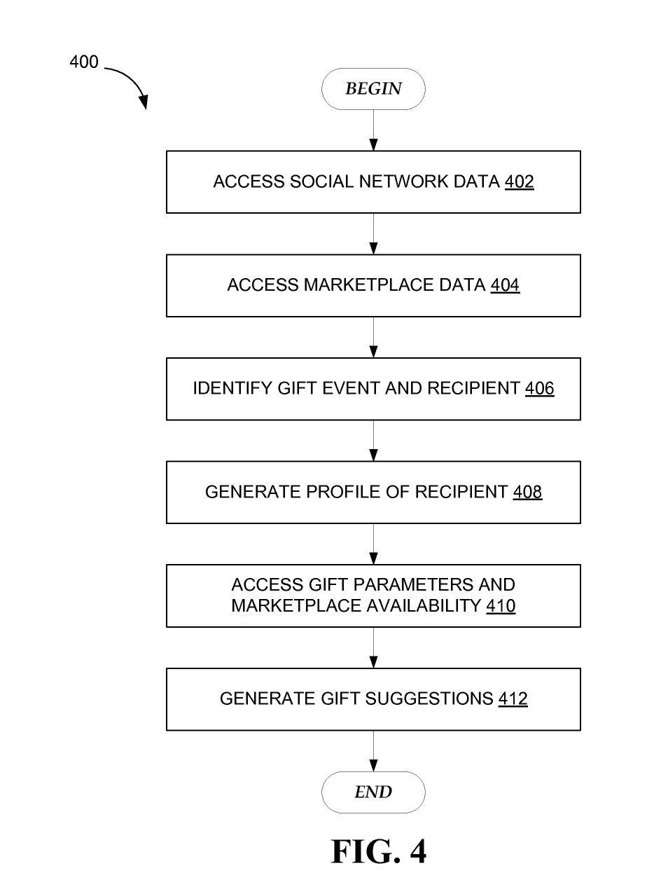

FIG. 4 shows a flow diagram illustrating one example embodiment of a method 400 of the social gifting application 122. At operation 402, the social gifting application 122 accesses social network data from social network service providers. In one example embodiment, operation 402 may be implemented using the social network interface module 302.

At operation 404, the social gifting application 122 accesses marketplace data from the marketplace application 120. In one example embodiment, operation 404 may be implemented using the marketplace interface module 304.

At operation 406, the social gifting application 122 identifies a gift event and a gift recipient associated with the gift event. In one example embodiment, operation 406 may be implemented using the gift event identifier module 306.

At operation 408, the social gifting application 122 generates a profile of the gift recipient. In one example embodiment, operation 408 may be implemented using the gift profile generator module 308.

At operation 410, the social gifting application 122 accesses gift parameters and marketplace availability of suggested products. In one example embodiment, operation 410 may be implemented using the gift parameters module 308. The gift parameters module 308 may present the parameters to the user for the user to select the parameters.

At operation 412, the social gifting application 122 generates a gift suggestion (e.g., a list of products or categories). The gift suggestion is generated based on the gift event, gift parameters, and availability of products. In one example embodiment, operation 412 may be implemented using the gift suggestion module 312.

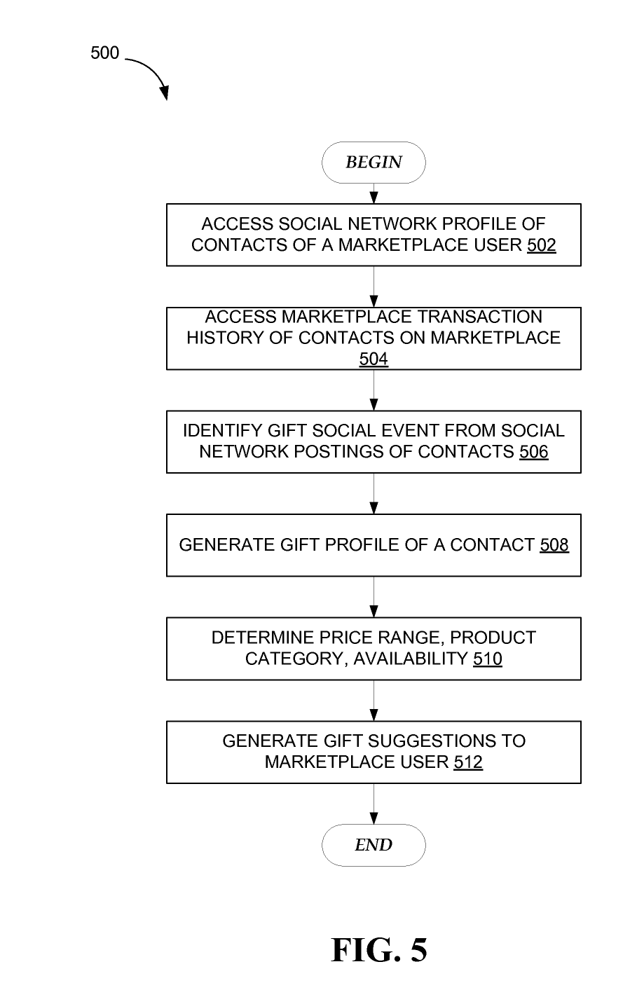

FIG. 5 shows a flow diagram illustrating a further example embodiment of a method 500 of the social gifting application 122. At operation 502, the social gifting application 122 accesses social network profiles of contacts (e.g., friends) of a user. In one example embodiment, operation 502 may be implemented using the social network interface module 302.

At operation 504, the social gifting application 122 accesses marketplace transaction history of the contacts from the marketplace application 120. In one example embodiment, operation 504 may be implemented using the marketplace interface module 304.

At operation 506, the social gifting application 122 identifies a gift social event from social network postings from the contacts or from a profile of the contacts (e.g., birthday). In one example embodiment, operation 506 may be implemented using the gift event identifier module 306.

At operation 508, the social gifting application 122 generates a gift profile of the contact. In one example embodiment, operation 508 may be implemented using the gift profile generator module 308.

At operation 510, the social gifting application 122 determines price range, product category, and product availability. The price range, product category, and other parameters may be determined based on a selection by the user. For example, a range of prices may be presented to the user, and the user selects a range. Similarly, a plurality of categories may be presented to the user, and the user selects one category. For example, a parameter may include products only from sellers local (e.g., within the same country or within a predetermined distance) to the gift recipient. Other parameters may be related to shipping conditions (e.g., free shipping, two-day shipping, arrival by a specified date (Christmas), local delivery). Other parameters may be related to the product conditions (e.g., refurbished, new, used).

In one example embodiment, operation 510 may be implemented using the gift parameters module 308.

At operation 512, the social gifting application 122 generates gift suggestions (e.g., a list of products or categories) for the user. The gift suggestions take into account, the selected price range, the selected product category, and product availability from the marketplace. In one example embodiment, operation 512 may be implemented using gift suggestion module 312. The social gifting application 122 presents the gift suggestions to the user for selection. The user can select a product or item to gift from the gift suggestions to order the product or item from the marketplace application 120. The marketplace application 120 generates a transaction where the user pays for the product or item, requests the seller of the product or item to ship the product or item to an address of the gift recipient. The address of the gift recipient may be provided to the seller without displaying the address to the user.

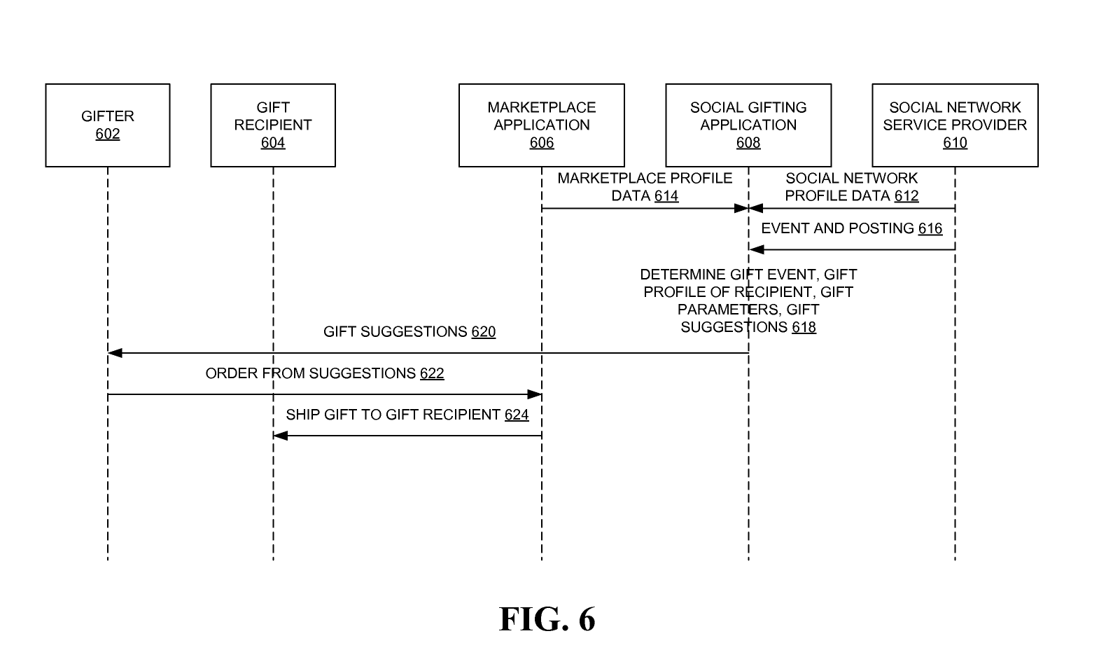

FIG. 6 shows an interaction diagram illustrating one example embodiment of an operation of a social gifting application 608. At operation 612, the social gifting application 608 accesses social network profile data 612 from a social network service provider 610. At operation 614, the social gifting application 608 accesses marketplace profile data 614 from a marketplace application 606. At operation 616, the social gifting application 608 receives updates such as events and postings from the social network service provider 610 related to the social network connections of a user of the marketplace application 606. At operation 618, the social gifting application 608 generates gift suggestions based on a social event, profile of the recipient, and gift parameters. At operation 620, the social gifting application 608 displays (or causes to be displayed on a device of the user) the gift suggestions to a user or gifter 602. The gifter 602 orders a product from the gift suggestions at operation 622. At operation 624, the marketplace application 606 causes the selected product to be shipped to the gift recipient 604. For example, a seller may be notified by the marketplace application 606 to ship the selected product and be provided shipping information for the gift recipient.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via network 104 (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, (e.g., a computer program tangibly embodied in an information carrier, e.g., in a machine-readable medium for execution by, or to control the operation of, data processing apparatus, e.g., a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware, may be a design choice. Below are set out hardware (e.g., machine) and software architectures that may be deployed in various example embodiments.

### Example Computer System

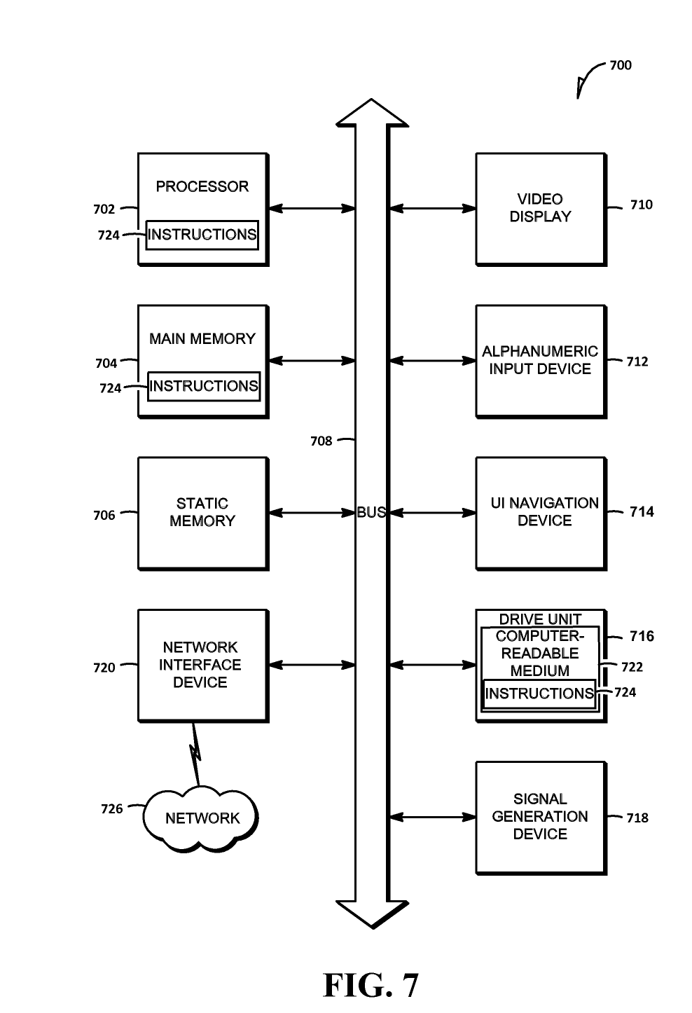

FIG. 7 shows a diagrammatic representation of a machine in the example form of a computer system 700 within which a set of instructions 724 may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine 110 or 112 in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions 724 (sequential or otherwise) that specify actions to be taken by that machine. Further, while only a single machine is illustrated, the term “machine” shall also be taken to include any collection of machines that individually or jointly execute a set (or multiple sets) of instructions 724 to perform any one or more of the methodologies discussed herein.

The example computer system 700 includes a processor 702 (e.g., a central processing unit (CPU), a graphics processing unit (GPU, or both)), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a UI navigation device 714 (e.g., a mouse), a disk drive unit 716, a signal generation device 718 (e.g., a speaker), and a network interface device 720.

The drive unit 716 includes a computer-readable medium 722 on which is stored one or more sets of data structures and instructions 724 (e.g., software) embodying or utilized by any one or more of the methodologies or functions described herein. The instructions 724 may also reside, completely or at least partially, within the main memory 704 or within the processor 702 during execution thereof by the computer system 700, with the main memory 704 and the processor 702 also constituting machine-readable media.

The instructions 824 may further be transmitted or received over a communications network 826 using a transmission medium via the network interface device 820 and utilizing any one of a number of well-known transfer protocols (e.g., HTTP). Examples of communication networks include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions for execution by the machine, and includes digital or analog communications signals or other intangible medium to facilitate communication of such software.

While the computer-readable medium 722 is shown in an example embodiment to be a single medium, the term “computer-readable medium” should be taken to include a single medium or multiple media (e.g., a centralized or distributed database, and/or associated caches and servers) that store the one or more sets of instructions 724. The term “computer-readable medium” shall also be taken to include any medium that is capable of storing, encoding, or carrying a set of instructions 724 for execution by the machine and that cause the machine to perform any one or more of the methodologies of the present disclosure, or that is capable of storing, encoding or carrying data structures utilized by or associated with such a set of instructions 724. The term “computer-readable medium” shall, accordingly, be taken to include, but not be limited to, solid-state memories, optical media, and magnetic media.

Furthermore, the machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A system comprising:
a social network interface module to access social network data of contacts of a social network of a user from a social network service provider;
a marketplace interface module to access marketplace data of the contacts and the user from a marketplace application;
a gift event identifier module to identify a gift event based on the social network data of a contact of the user, and identify the contact of the user as a gift recipient;
a gift profile generator module to generate a gift profile of the gift recipient based on the social network data of the gift recipient;
a gift parameter module to access gift parameters of the user and product availability from the marketplace application; and
a gift suggestion module, comprising a hardware processor, to generate a gift suggestion based on the gift event of the gift recipient, the gift profile of the gift recipient, and the gift parameters to the user.

2. The system of claim 1, wherein the social network data comprises a profile of the contact and a posting from the contact with the social network service provider.

3. The system of claim 2, wherein the gift event identifier module is to identify key words from the posting, and to correlate the posting with a gift category based on the key words.

4. The system of claim 2, wherein the gift event identifier module is to correlate a social event from the profile of the contact with a gift category.

5. The system of claim 1, wherein the marketplace data comprises historical transaction data from the user and the contacts from the marketplace application.

6. The system of claim 5, wherein the gift profile generator module is to generate the gift profile based on the historical transaction data of the gift recipient.

7. The system of claim 1, wherein the gift profile generator module is configured to identify product categories based on a marketplace application browsing history of the gift recipient and past purchases of the gift recipient.

8. The system of claim 1, wherein the gift profile generator module is configured to map product categories corresponding to social events of the gift recipient or postings from the gift recipients.

9. The system of claim 8, wherein the gift parameter module is to present the product categories and a plurality of price ranges to the user, and to receive a selection of at least one product category and at least one price range from the user.

10. The system of claim 9, wherein the gift suggestion module is configured to:
identify a product based on the selected product category and price range;
determine an availability of the product in the marketplace application; and
cause the product to be presented on a user interface of the user as the gift suggestion for the gift recipient.

11. A method comprising:
accessing social network data of contacts of a social network of a user from a social network service provider, and marketplace data of the contacts and the user from a marketplace application;
identifying a gift event based on the social network data of a contact of the user, the contact being a gift recipient;
generating a gift profile of the gift recipient based on the social network data of the gift recipient;
accessing gift parameters of the user and product availability from the marketplace application; and
generating, by a hardware processor, a gift suggestion based on the gift event of the gift recipient, the gift profile of the gift recipient, and gift parameters to the user.

12. The method of claim 11, wherein the social network data comprises a profile of the contact and a posting from the contact with the social network service provider.

13. The method of claim 12, further comprising:
identifying key words from the posting; and
correlating the posting to a gift category based on the key words.

14. The method of claim 12, further comprising:
correlating a social event from the profile of the contact with a gift category.

15. The method of claim 11, wherein the marketplace data comprises historical transaction data from the user and the contacts from the marketplace application.

16. The method of claim 15, further comprising:
generating the gift profile of the gift recipient based on the historical transaction data of the gift recipient.

17. The method of claim 11, further comprising:
identifying product categories based on a marketplace application browsing history of the gift recipient and past purchases of the gift recipient.

18. The method of claim 11, further comprising:
mapping product categories corresponding to social events of the gift recipient or postings from the gift recipients.

19. The method of claim 18, further comprising:
presenting the product categories and a plurality of price ranges to the user;
receiving a selection of at least one product category and at least one price range from the user;
identifying a product based on the selected product category and price range;
determining an availability of the product in the marketplace application; and
causing presentation on a user interface to the user with the product as the gift suggestion for the gift recipient.

20. A non-transitory computer-readable storage medium storing a set of instructions that, when executed by a processor of a machine, cause the machine to perform operations, comprising:
accessing social network data of contacts of a social network of a user from a social network service provider, and marketplace data of the contacts and the user from a marketplace application;
identifying a gift event based on the social network data of a contact of the user, a gift recipient including the contact of the user;
generating a gift profile of the gift recipient based on the social network data of the gift recipient;
accessing gift parameters of the user and product availability from the marketplace application; and
generating a gift suggestion based on the gift event of the gift recipient, the gift profile of the gift recipient, and gift parameters to the user.
